(19) United States
(12) Patent Application Publication
(10) Pub. No.: US 2009/0133303 A1
(43) Pub. Date: May 28, 2009

(54) Snap mobile for advertising a product and a method of forming the snap mobile

(75) Inventor: Paula F. Condor, Oshkosh, WI (US)

Correspondence Address: WILHELM LAW SERVICE, S.C., 100 W LAWRENCE ST, THIRD FLOOR, APPLETON, WI, 54911, US

(73) Assignee: Promo Print Solutions, Inc., Oshkosh, WI (US)

(21) Appl. No.: 12/154,583

(22) Filed: May 23, 2008

Related U.S. Application Data
(60) Provisional application No. 60/931,739, filed on May 25, 2007.

(51) Int. Cl. G09F 7/12; G09F 7/00

(52) U.S. Cl. 40/610; 40/594

(57) ABSTRACT

This invention relates to a snap mobile for advertising a product or event and a method of forming the snap mobile. The snap mobile includes a display card having a length and a width. The width is divided by an odd number of score lines into n equally wide panels. One of the score lines is an intermittent score line having a plurality of land areas each separated by a perforation. An attachment mechanism is positioned on at least a portion of the first panel. The first panel is then overlapped onto the n^{th} panel, the second panel is overlapped onto the n−1 panel, etc. The n−1 panel is then folded upon the n^{th} panel to form a relatively flat snap mobile which can be easily shipped. The snap mobile has at least three legs and is visible from all directions.

### CROSS REFERENCE TO RELATED APPLICATION

This patent application is a regular patent application claiming priority to U.S. Provisional patent application U.S. Ser. No. 60/931,739, filed May 25, 2008.

### FIELD OF THE INVENTION

This invention relates to a snap mobile for advertising a product or event and a method of forming the snap mobile. More specifically, this invention relates to a snap mobile that can be hung from an elevated member, be positioned on a counter or be situated on the floor, for example, at the end of an aisle, for advertising one or more products or events.

### BACKGROUND

Today, there are a wide variety of product displays used to advertise various products, articles and/or events. Such product displays are normally formed from cardboard, pasteboard or stiff paper and can be constructed in various sizes and shapes. The product displays are usually printed to include information in the form of words, letters, numbers, paragraphs, graphics, images, etc. or a combination thereof, urging a consumer to purchase a particular product, article or to take in a specific event, such as a movie. These product displays can appear in a grocery store, for example, as a stand up display at the end of an aisle, in a convenience store as a countertop display, or in a car dealer's showroom as a full size display or a smaller version that hangs down from a ceiling. Such product displays can also be hung from a shelf, from a ceiling or even from another display. The snap mobiles can further be displayed as a pole topper or as a display topper. Such product displays are commonly used to promote various items, including but not limited to: the sale of soft drinks, bottled water, beer, alcohol, food items, especially candy or sweets, disposable consumer products, movies, music, compact disks, automobiles, trucks, motorcycles, all terrain vehicles, bicycles, etc.

One drawback with some such product displays is that they are one dimensional. In other words, they can be viewed from only one side. The side edges of such product displays are very narrow, usually ⅛ of an inch or less and the back surface of such a product display is not printed and carries no advertisement. In fact, the back surface of such a product display is normally positioned adjacent to a wall or a stationary object such that it is not readily visible to the consumer. Other product displays contain printing on two opposing surfaces but require a base or stand to hold the product display in a vertical and upright position. The base or stand has to be made of a material that is sufficiently strong and sturdy to hold the product display. Many bases and stands project outward from the product display and a potential consumer can easily tripped over or step on such supports. This presents a safety hazard. In addition, the cost of manufacturing the base or stands can greatly increase the total cost of the product display.

Still other product displays come with multiple sides and unique geometrical shapes. These product displays can be viewed from various directions, some can be viewed from 360 degrees. These product displays are more likely to be seen and read by potential consumers and can lead to increased sales for the retailer and the original product manufacturer. However, many of these multisided product displays can not be folded into a relatively flat orientation for shipment to the retailer. Because of this, the shipping cost can become excessive. Another drawback is that some of these multisided product displays need to be carefully assembled at the retail store in order for them to stand up properly. This can be a time consuming task that no one enjoys doing. Feedback to advertisers has indicated that up to 40 percent of all corrugated displays that are shipped to retail stores are not used because of the time and complexity required to set them up.

Therefore, there is a need for a multisided product display that can be folded into a relatively flat orientation for shipment to a retailer, which is also easy to unfold such that it can be quickly positioned in a visible location, and which will be sturdy enough to maintain its unfolded configuration.

### SUMMARY

This invention relates to a snap mobile for advertising a product, article or event and a method of forming the snap mobile. The snap mobile is a display card having a first major surface and an oppositely aligned second major surface. The display card has a width, an upper edge and a lower edge. The display card is divided along the width by a number of score lines into n equally wide panels. Desirably, an odd number of linear score lines are formed which divide the width of the display card into an even number of panels. For example, the width of the display card can be divided by at least five score lines into at least a first panel, a second panel, a third panel, a fourth panel, a fifth panel and a sixth panel, each of said panels having an equal width. Alternatively, the two end panels could be of a different width from the other panels. The score lines can extend vertically from approximately the upper edge to approximately the lower edge. One of the score lines is an intermittent score line formed at the midsection of the width of the display card when six panels are present. The intermittent score line has a plurality of land areas each separated by a perforation.

An attachment mechanism, such as an adhesive, is applied to a portion of the second major surface of the display card. When the attachment mechanism is an adhesive, it should be located on at least three of the panels, and desirably, on every other panel.

In the case where six panels are present, the first panel is overlapped onto the sixth panel, the second panel is overlapped by the third panel, and the fourth panel is overlapped onto the fifth panel. The first panel is then secured to the sixth panel by the attachment mechanism, the second panel is secured to the third panel by the attachment mechanism, and the fourth panel is secured to the fifth panel by the attachment mechanism. The fourth and fifth panels are then folded upon the sixth panel to form a relatively flat snap mobile which can be easily shipped.

The method of forming a snap mobile includes the steps of unwinding a strip of material from a supply roll. The strip of material has a first major surface and an oppositely aligned second major surface. Desirably, at least the first major surface has already been printed with predetermined information and/or colors which may include letters, words, numbers, images, graphical symbols, icons, etc. The strip is cut into individual display cards each having a length, a width, an upper edge and a lower edge. A number of score lines, desirably an odd number of linear score lines, are then formed into at least one of the first and second major surfaces of the individual display cards. The scoring can divide the width into n equally wide panels.

One of the score lines is an intermittent score line that is formed at a midsection of the width of each of the individual display cards. The intermittent score line has a plurality of land areas each separated by a perforation. An attachment mechanism, for example an adhesive, is applied to a portion of the second major surface. The adhesive is located on at least three panels, desirably on every other panel. The first panel 28, labeled 1, is then overlapped onto the n^{th} panel 28, the second panel 28, labeled 2, is overlapped by the n−1 panel, etc. The first panel 28, labeled 1, is secured to the n^{th} panel by the attachment mechanism, i.e. an adhesive, the second panel 28, labeled 2, is secured to the n−1 panel by the attachment mechanism, etc. The n−1 and n−2 panels are then folded upon the n^{th} panel to form a relatively flat snap mobile which can be easily shipped.

The general object of this invention is to provide a snap mobile for advertising a product, article or event that can be viewed from various sides. A more specific object of this invention is to provide a snap mobile that can be folded into a relatively flat orientation for shipment to a retailer and then be quickly and easily unfolded into a sturdy product display having at least three sides.

Another object of this invention is to provide a snap mobile for advertising a product, article or event that can be positioned on the floor, on a countertop, be hung from a ceiling or be hung from an elevated member.

Still another object of this invention is to provide a snap mobile for advertising a product, article or event that can stand by itself without the need for a base or stand.

Still further, an object of this invention is to provide a snap mobile for advertising a product, article or event that has a unique hinge that permits the snap mobile to be folded upon itself into a compact shape and be unfolded into a multisided product display having at least three legs.

Still another object of this invention is to provide a snap mobile that can be mounted on a pole and be used as a pole topper or display topper for advertising a product, article or event.

These and other objects and advantageous of the present invention will be apparent from the embodiments described herein.

### BRIEF DESCRIPTION OF THE DRAWINGS

FIG. 1 is a front view of a display card having a length, a width, an upper edge and a lower edge, and which is divided into six panels by five score lines with one of the score lines being an intermittent score line having a plurality of land areas each separated by a perforation.

FIG. 2 is a top view of the display card shown in FIG. 1.

FIG. 3 is a perspective view of the display card once it is folded and secured together to form a snap mobile.

FIG. 4 is a front view of the six panel snap mobile after it has been folded upon itself into a two panel, relatively flat orientation for shipment to a retailer.

FIG. 5 is a top view of the snap mobile shown in FIG. 4 once it has been completely opened into a three legged configuration with each panel spaced approximately 120 degrees apart.

FIG. 6 is an alternative embodiment of a display card having a non-rectangular shape and having six apertures form adjacent to the upper edge which permit the finished snap mobile formed from the display card to be hung by a line or wire from a ceiling or some other elevated member.

FIG. 7 is a perspective view of a snap mobile formed from the display card shown in FIG. 6 depicting it in a semi-open position and having a line, such as an elongated string, attached to an overhead support member.

FIG. 8 is a top view of the snap mobile shown in FIG. 7 when it is in an open configuration showing three legs spaced approximately 120 degrees apart.

FIG. 9 is a front view of still another embodiment showing a display card having a length, a width, an upper edge and a lower edge, and being divided into eight panels by seven linear score lines, with two of the score lines being intermittent score lines.

FIG. 10 is a top view of the display card shown in FIG. 9.

FIG. 11 is a top view of the snap mobile formed from the display card shown in FIG. 9 after it has been folded upon itself and then having a pair of panels folded upon adjacent panels to obtain a relatively flat orientation for shipment to a retailer.

FIG. 12 is a front view of an eight panel snap mobile after it has been folded upon itself into a two panel, relatively flat orientation for shipment to a retailer.

FIG. 13 is a top view of the snap mobile formed from the display card shown in FIG. 9 when it is in an open configuration showing four legs spaced approximately 90 degrees apart.

FIG. 14 is a schematic of a flow method for forming a snap mobile from a strip of material wound on a supply roll.

FIG. 15 is a side view of a blade used to form an intermittent score line in the display card.

### DETAILED DESCRIPTION OF THE INVENTION

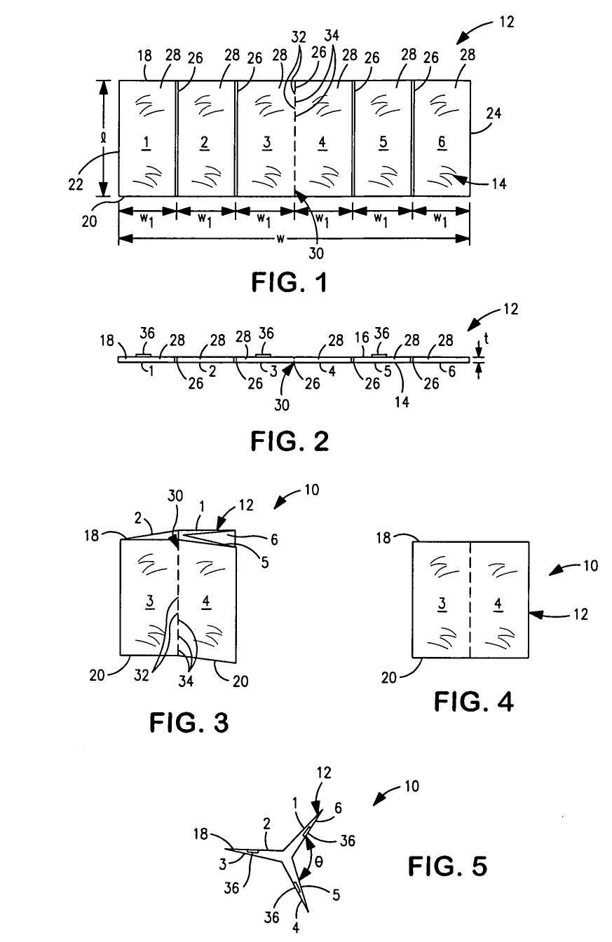

Referring to FIGS. 1-3, a snap mobile 10, see FIG. 3, is formed from a display card 12, see FIGS. 1 and 2. The snap mobile 10 is a display for advertising a product, article and/or event. The snap mobile 10 is formed from the display card 12. The display card 12 has a first major surface 14 and an oppositely aligned second major surface 16, see FIG. 2. Desirably, the first major surface 14 is fairly smooth and is acceptable to having information printed thereon. Desirably, the first major surface 14 is pre-printed before being cut, scored or folded. The second major surface 16 commonly is left blank and is not printed. Alternatively, the second major surface 16 can also be printed so that when the display card 12 is cut and/or folded, the color of the non-printed material will not be visible to the ultimate consumer.

Referring to FIG. 2, the display card 12 has a thickness t measured between the first and second major surfaces, 14 and 16 respectively. The thickness t can range from about 1 millimeter to about 15 millimeters. Desirably, the thickness t is less than about 10 millimeters. More desirably, the thickness t is less than about 7 millimeters. Even more desirably, the thickness t is less than about 5 millimeters. Alternatively, the snap mobile 10 can be constructed from board stock having a thickness t of from between about 6 points to about 40 points.

The display card 12 can have almost any geometrical shape. In FIGS. 1 and 2, the display card 12 is depicted as a rectangle having a length l and a width w. The rectangle can be cut out of an elongated strip of pre-printed material which is unwound from a supply roll or it can be cut out of individual sheets. The length l and the width w of the display card 12 can vary to suit one's particular needs. The length l can range from a couple of inches to several feet, and the width w can range from a couple of inches to several feet. For example, some snap mobiles 10 have been constructed to be 6 feet long and 6 feet wide. The display card 12 also has an upper edge 18, a lower edge 20 and a pair of side edges 22 and 24.

The display card 12 can be formed from any known material, but usually is formed from a material that is relatively light weight. The material should also have a smooth surface that is easy to print information on. The information can be in the form of letters, numbers, words, sentences, paragraphs, an image, an icon, a graphic, a photograph, etc. Examples of such materials from which the display card 12 can be formed include, but are not limited to: stiff paper, paperboard, cardboard, thin pasteboard, corrugate or corrugated paper sandwiched between two sheets of paper, plastic, styrene, foam, a lightweight core sandwiched between two sheets of paper, or from a combination of such materials. In addition, the display card 12 can be constructed from a light weight material, such as styrene, foam, solid bleached sulfate and the like, which is sandwiched between two paper sheets. Desirably, the snap mobile 10 is formed from a display card that is made from stiff paper, paperboard, cardboard, thin pasteboard or corrugated paper sandwiched between two sheets of paper. For a harsh environment, such as for an outdoor display or for a display housed in a cooler, the display card 12 can be constructed out of plastic or synthetic paper.

As mentioned above, the first major surface 14 of the display card 12 should be smooth and acceptable to having information printed on it. Various printing techniques known to those skilled in the printing arts can be used. The display card 12 should also be formed from a material that is easy to cut and fold. For example, the display card 12 should be acceptable to being cut by die cutting or the like and should be acceptable to being easily folded along one or more predetermined score lines. In addition, it should be relatively easy to punch or form holes in the display card 12.

Referring again to FIGS. 1 and 2, the display card 12 is divided along its width w by a number of score lines 26 into n panels 28. The score lines 26 are vertically arranged in FIGS. 1 and 2. It is advantageous to pre-print the first major surface 14 of the display card 12 before the score lines 26 are formed. However, if one wished to score the display card 12 prior to printing the first major surface 14, this is possible. Desirably, an odd number of score lines 26 are utilized which divide the display card 12 into an even number of equally wide panels 28. For example, as depicted in FIG. 1, five score lines 26 divide the display card 26 into six equally width panels 28. The score lines 26 can be linear or arcuate in configuration. Desirably, each of the score lines 26 is linear.

By forming an odd number of score lines 26, one will end up with an even number of panels 28. Each of the score lines 26 extends inward into the thickness t of the display card 12 from at least one of the first or second major surfaces, 14 or 16 respectively, by a distance of from between about 5% to about 90% of the thickness t. Desirably, each of the score lines 26 extend inward into the thickness t of the display card 12 from at least one of the first or second major surfaces, 14 or 16 respectively, by a distance of from between about 10% to about 50% of the thickness t. More desirably, each of the score lines 26 extend inward into the thickness t of the display card 12 from at least one of the first or second major surfaces, 14 or 16 respectively, by a distance of from between about 15% to about 40% of the thickness t. Even more desirably, each of the score lines 26 extends inward into the thickness t of the display card 12 from at least one of the first or second major surfaces, 14 or 16 respectively, by a distance of from between about 20% to about 30% of the thickness t.

Desirably, the score lines 26 are formed in the first major surface 14. However, in some embodiments, it may be advantageous to form the score lines 26 in the second major surface 16. Alternatively, one could form the score lines 26 in both the first and second surfaces, 14 and 16 respectively, of the display card 12.

The score lines 26 are aligned essentially parallel to one another and desirably, are aligned parallel to one another. The score lines 26 can extend from approximately the upper edge 18 to approximately the lower edge 20. Desirably, the score lines 26 extend from the upper edge 18 to the lower edge 20. A majority of the score lines 26 can be continuous straight lines formed by displacing the material from which the display card 12 is formed.

Still referring to FIGS. 1 and 2, the display card 12 is divided into a number of n panels 28. Each of the panels 28 can have an identical configuration. The number n can vary from six, as shown in FIG. 1, to eight, ten, twelve, etc. Typically, six or eight panels 28 are sufficient for constructing a finished snap mobile 10 that can be view from multiple sides. Desirably, the snap mobile 10 can be viewed by a potential consumer from 360 degrees. In FIGS. 1 and 2, the six panels 28 are labeled 1, 2, 3, 4, 5 and 6. Each of the six panels 28 has a width w₁. The width w₁ of each of the six panels 28, labeled 1, 2, 3, 4, 5 and 6 are equal or approximately equal in dimension.

The snap mobile 10 also includes at least one intermittent score line 30. Desirably, the intermittent score line 30 is formed in the first major surface 14 although it could be formed in the second major surface 16, if desired. In FIG. 1, where six panels 28 are present, the intermittent score line 30 is shown being formed at a midsection of the width w of the display card 12. The intermittent score line 30 is aligned parallel with at least one of the other score lines 26, and desirably, is aligned parallel to each of the other score lines 26. The intermittent score line 30 extends approximately between the upper edge 18 and the lower edge 20. Desirably, the intermittent score line 30 extends from the upper edge 18 to the lower edge 20.

The intermittent score line 30 is formed from a plurality of land areas 32 each separated by a perforation 34. By “perforation” it is meant a depression, a cut, a slot, a hole or series of depressions, cuts, slots, holes punched or bored into or through something. Each of the perforations 34 can be formed along a linear or non-linear line. Each of the perforations 34 can be formed in a series to separate different sections of a sheet or sections of a roll. Each of the land areas 32 is separated by a perforation 34 in an intermittent fashion. By “intermittent” it is meant a line that starts and stops at intervals. The perforations 34 can, but do not have to, extend completely through the thickness t of the display card 12. Desirably, the perforations 34 do not extend completely through the thickness of the display card 12.

The length of each of the plurality of land areas 32, as well as the length of each perforation 34, can vary. The length of each of the plurality of land areas 32 can be less than, equal to or be greater than the length of each of the perforations 34. Likewise, the total number of land areas 32 can be less than, equal to or be greater than the total number of perforations 34. Normally, the number of land areas 32 will be equal to the number of perforations 34 or the number of land areas 32 will be one less than or one more than the number of perforations 34. It is also possible to change the length of each of the plurality of land areas 32 and/or the length of each of the perforations 34 along the length of the intermittent score line 30. Typically, each of the plurality of land areas 32 will have a constant length dimension and each of the perforations 34 will have a constant length dimension. The length of each of the plurality of land areas 32 can range from between about 0.01 inches to about 2 inches. Desirably, the length of each of the plurality of land areas 32 can range from between about 0.05 inches to about 1 inch. More desirably, the length of each of the plurality of land areas 32 can range from between about 0.1 inches to about 0.5 inches. Even more desirably, the length of each of the plurality of land areas 32 can range from between about 0.125 inches to about 0.4 inches.

Likewise, the length of each of the plurality of perforations 34 can range from between about 0.01 inches to about 2 inches. Desirably, the length of each of the plurality of perforations 34 can range from between about 0.05 inches to about 1 inch. More desirably, the length of each of the plurality of perforations 34 can range from between about 0.1 inches to about 0.5 inches. Even more desirably, the length of each of the plurality of perforations 34 can range from between about 0.125 inches to about 0.4 inches.

Like the score lines 26, the intermittent score line 30 does not extend completely through the thickness t of the display card 12. However, the intermittent score line 30 could extend completely through the thickness t of the display card 12, if desired. The intermittent score line 30 should extend inward from the first major surface 14 a distance of from between about 5% to about 90% of the thickness t of the display card 12. Desirably, the intermittent score line 30 could extend inward from the first major surface 14 a distance of from between about 10% to about 50% of the thickness t of the display card 12. More desirably, the intermittent score line 30 could extend inward from the first major surface 14 a distance of from between about 15% to about 40% of the thickness t of the display card 12. Even more desirably, the intermittent score line 30 could extend inward from the first major surface 14 a distance of from between about 20% to about 30% of the thickness t of the display card 12.

It should be noted that the score lines 26 and the intermittent score line 30 have been described as extending inward into the display card 12 from the first major surface 14. However, if desired, some or all of the score lines 26 and the intermittent score line 30 can extend inward from the second major surface 16. Alternatively, one or more of the score lines 26 can be a relatively short segment that is combined with a die cut to form a foldable line on which the display card 12 can be folded.

Referring again to FIG. 2, the display card 12 further includes one or more attachment mechanisms 36. Three attachment mechanisms 36 are shown in FIG. 2. However, any number of attachment mechanisms 36 can be present. The attachment mechanism 36 can be a chemical compound or formulation, such as an adhesive or glue, or be a mechanical fastener, such as one or more staples, pins, clips, etc. Desirably, the attachment mechanism 36 is an adhesive that can adhere or stick to a panel 28. The adhesive can be a hot melt adhesive, a cold melt adhesive, a co-adhesive, a paste, cement, glue, or any other adhesive known to those skilled in the adhesive art.

When the attachment mechanism 36 is an adhesive or glue, it can be positioned or applied onto at least a portion of the second major surface 16. The adhesive or glue can be applied to a single panel 28 or to two or more panels 28. For example, the adhesive or glue can be applied to every panel 28, or to every other panel 28, such as panels 28, labeled 1, 3 and 5 or the panels 28, labeled 2, 4 and 6. Alternatively, the adhesive can be applied to the panels 28, labeled 1, 2 and 4 or the panels 28, labeled 3, 5 and 6. The adhesive can be applied in various ways, including but not limited to: being coated such as by line coating or slot coating, or be brushed, painted, applied in a swirl pattern, etc. onto the second major surface 16. Those familiar with the applications of adhesive and glue will know of still other ways to apply the adhesive or glue.

When the attachment mechanism 36 is a mechanical fastener, such as pins, staples, clips, etc., they can be inserted along the pair of side edges 22 and 24 to hold the panels 28, labeled 1 and 6 together. Additional pins, staples, clips, etc. can also be applied to each of the other pairs of panels 28, such as to the panels 28, labeled 2 and 3, and 4 and 5. Those skilled in mechanical fasteners will know of various other apparatus and methods which can be used to attach one or more of the panels 28 to form the configuration shown in FIG. 5.

Referring now to FIGS. 3 and 4, after the attachment mechanism 36, in the form of an adhesive or glue, has been applied to the second major surface 16, the display card 12 is folded. The folding can be done by hand or by using a mechanical folder. The display card 12 is initially folded upon itself. In the six panel profile shown in FIGS. 1 and 2, the panel 28, labeled 1 is folded or reconfigured to overlap the panel 28, labeled 6. In other words, the panel 28, labeled 1, also referred to as the first or n−5 panel, is overlapped by the n^{th} panel. The panel 28, labeled 2, also referred to as the second or the n−4 panel, is folded or reconfigured to overlap the panel 28, labeled 3, also referred to as the third or the n−3 panel. Likewise, the fourth panel 28, labeled 4 is folded or reconfigured to overlap the panel 28, labeled 5, also referred to as the fifth or n−1 panel.

At least a portion of the first panel 28, labeled 1 is bonded to the sixth panel 28, labeled 6 by the attachment mechanism 36. Likewise, at least a portion of the second panel 28, labeled 2 is bonded to the third panel 28, labeled 3 by the attachment mechanism 36 and at least a portion of the fourth panel 28, labeled 4 is bonded to the fifth panel 28, labeled 5 by the attachment mechanism 36. If desired, only the first panel 28, labeled 1 can be bonded to the sixth panel 28, labeled 6. When this is the case, the second and third panels 28, labeled 2 and 3 respectively, and the fourth and fifth panels 28, labeled 4 and 5 respectively, can be retained adjacent to one another by the stiffness of the material from which the display card 12 is formed and/or by the amount of penetration of the score lines 26 and 30.

After the initial fold or reconfiguration, the fourth and fifth panels 28, labeled 4 and 5 respectively, form a set that is folded onto or in an overlapping fashion over the sixth panel 28, labeled 6, see FIG. 3. This produces a relatively flat; two panel wide structure as depicted in FIG. 4. This relatively flat snap mobile 10 is compact and can be easily boxed and shipped to a retailer or other consumer.

Referring to FIG. 5, a top view of the snap mobile 10 is shown once the three sets of panels 28, labeled 1 and 6, 2 and 3, and 4 and 5 are unfolded. The snap mobile 10 has three legs, with each of the legs being spaced approximately 120 degrees apart. Each leg is constructed from a pair of the panels 28. Each of the three sets of panels 28, labeled 1 and 6, 2 and 3, and 4 and 5, can be spaced apart at an angle θ. Desirably, the angle θ is approximately 120 degrees. However, it is possible to space the three sets of the panels 28, labeled 1 and 6, 2 and 3, and 4 and 5, at different degrees from one another. For example, the first set, consisting of the panels 28, labeled 1 and 6, can be spaced approximately 115 degrees apart from the second set, consisting of the panels 28, labeled 2 and 3, and be spaced approximately 125 degrees apart from the third set, consisting of the panels 28, labeled 4 and 5. This would mean that the second set, consisting of the panels 28, labeled 2 and 3 would be spaced approximately 120 degrees apart from the third set, consisting of the panels 28, labeled 4 and 5.

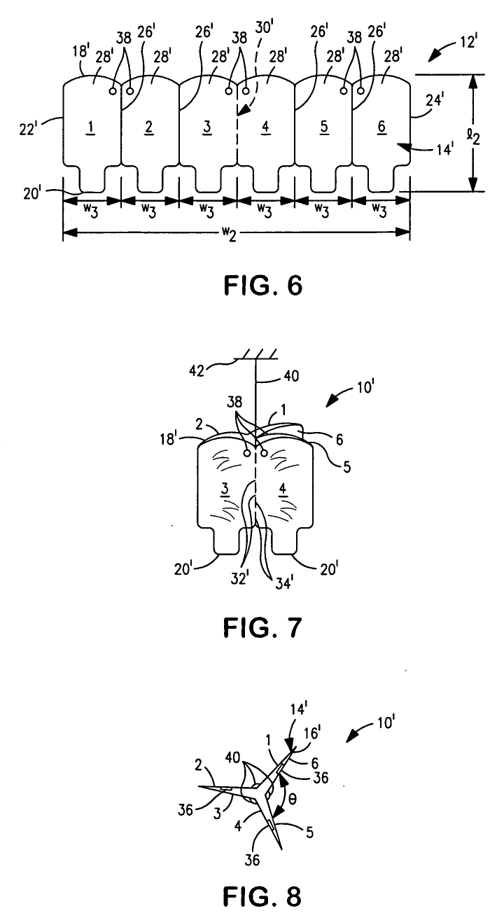

Referring now to FIGS. 6-8, an alternative embodiment is shown of a snap mobile 10′, constructed from a display card 12′, having a non rectangular shape or configuration, see FIG. 6. The configuration is similar to the outline of a one liter plastic cup for holding a soft drink. It should be recognized that any desired geometrical shape can be formed in the display card 12′.

The display card 12′ has a first major surface 14′ and an oppositely aligned second major surface 16′, see FIG. 8. The display card 12′ has a length l₂ and a width w₂. The display card 12′ has an upper edge 18′, a lower edge 20′ and a pair of side edges 22′ and 24′. In FIG. 6, the upper edge 18′ is scalloped and contains of a plurality of arcuate portions having a width w₃. The lower edge 20′ is flat but much narrower in width. The display card 12′ also includes an odd number of score lines 26′ and 30′ which divide the display card 12′ into an even number of n panels 28′. In this embodiment, n is equal to six. The panels 28′ are labeled 1, 2, 3, 4, 5 and 6. The panels 28′ can also be referred to as a first panel 28′ labeled 1, a second panel 28′ labeled 2, a third panel 28′ labeled 3, a fourth panel 28′ labeled 4, a fifth panel 28′ labeled 5, and a sixth panel 28′ labeled 6.

One of the score lines 26′ is an intermittent score line 30′ having a plurality of land areas 32′ each separated by a perforation 34′. The score line 30′ can be similar or identical to the score line 30 described in FIG. 1. The intermittent score line 30′ is shown being formed at a midsection of the width w₂ of the display card 12′. The intermittent score line 30′ is aligned parallel with at least one of the other score lines 26′, and desirably, is aligned parallel to each of the other score lines 26′. The intermittent score line 30′ extends approximately between the upper edge 18′ and the lower edge 20′. Desirably, the intermittent score line 30′ extends from the upper edge 18′ to the lower edge 20′.

The second major surface 16′ of the display card 12′ can have an attachment mechanism 36 applied to it, as was described above. Desirably, the attachment mechanism 36 is an adhesive that can be applied to at least a portion of the display card 12′. Desirably, the adhesive will be present on some or all of the six panels 28′. As one example, the adhesive can be applied to each alternating panel 28′, such as to the first panel 28′, labeled 1, to the third panel 28′ labeled 3, and to the fifth panel 28′, labeled 5.

The embodiment in FIG. 6 differs from that shown in FIG. 1, in that six apertures 38 are formed adjacent to the upper edge 18′. Each of the panels 28′, labeled 1, 2, 3, 4, 5 and 6 contain one of the apertures 38. The apertures 38 are grouped in pairs so that after the display card 12′ if folded or reconfigured, the aperture 38 in the first panel 28′, labeled 1, will line up with and be coaxially aligned with the aperture 38 formed in the sixth panel 28′, labeled 6. Likewise, the aperture 38 formed in the second panel 28′, labeled 2, will line up with and be coaxially aligned with the aperture 38 formed in the third panel 28′, labeled 3, and the aperture 38 formed in the fourth panel 28′, labeled 4, will line up with and be coaxially aligned with the aperture 38 formed in the fifth panel 28′, labeled 5. The apertures 38 extend completely through the display card 12′. The size and shape of the apertures 38 can vary but they desirably are small round holes.

Referring to FIGS. 7 and 8, the snap mobile 10′ is shown being suspended in the air by a line or wire 40 from an overhead support 42. The apertures 38 are sized and configured to receive the line or wire 40 and have it passed through at least one of them. Desirably, the line or wire 40 will pass through each of the apertures 38. The line or wire 40 can be in the form of a string formed from cotton, nylon or some other material, an elastic cord, a non-elastic cord, a rope, a ribbon, a metal wire, a chain, a plastic shelf hanger, etc. These and other forms of materials that can serve the same function as a line or wire 40 can be used. The line or wire 40 can be attached to the overhead member 42. The overhead member 42 can be a ceiling, a beam, a member that is cantilevered outward from another member, a rotatable mechanism, a light, or some other elevated member or structure. The line or wire 40 can be adjusted to any desired length and can be knotted at one or both ends.

When the snap mobile 10′ is in an open or unfolded orientation, it will be visible from multiple sides. Desirably, the snap mobile 10′ can be viewed from 360 degrees. Since the snap mobile 10′ is elevated relative to a person's eye level, it should be visible for some distance unless obstructed by a tall object. Such visibility will enhance the commercial importance of the snap mobile 10′. The snap mobile 10′ can also be hung off of a product shelf.

In FIG. 8, one will notice that the three sets of panels 28′ consisting of panels 28′, labeled 1 and 6, 2 and 3, and 4 and 5 are spaced apart from one another by an angle θ. Desirably, the angle θ is approximately 120 degrees. However, it is possible to space the three sets of panels 28′, labeled 1 and 6, 2 and 3, and 4 and 5, at different degrees from one another. For example, the first set, consisting of the panels 28′, labeled 1 and 6, can be spaced approximately 115 degrees apart from the second set, consisting of the panels 28′, labeled 2 and 3, and be spaced approximately 125 degrees apart from the third set, consisting of the panels 28′, labeled 4 and 5. This would mean that the second set, consisting of the panels 28′, labeled 2 and 3 would be spaced approximately 120 degrees apart from the third set, consisting of the panels 28′, labeled 4 and 5.

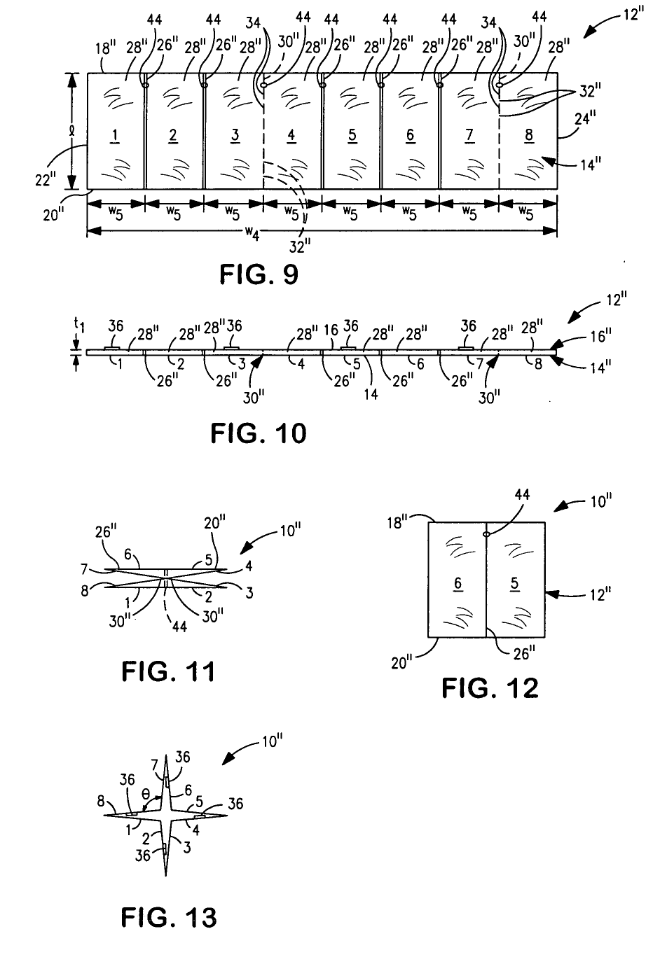

Referring now to FIGS. 9 and 10, a third embodiment is depicted showing a display card 12″. The display card 12″ can be folded or reconfigured into a snap mobile 10″, see FIGS. 11 and 12, which can be used to display advertising for a product, article and/or event. The display card 12″ has a first major surface 14″ and an oppositely aligned second major surface 16″, see FIG. 10. Desirably, the first major surface 14″ is fairly smooth and is acceptable to having information printed thereon. Desirably, the first major surface 14″ is pre-printed before being cut, scored or folded. The second major surface 16″ commonly is left blank and is not printed. However, the second major surface 16″ can be printed, if desired.

The display card 12″ has a thickness t₁ measured between the first and second major surfaces, 14″ and 16″ respectively. The thickness t₁ can vary in dimension as was recited above. The display card 12″ can have almost any geometrical shape. In FIGS. 9 and 10, the display card 12″ is depicted as a rectangle having a length l₄ and a width w₄. The rectangle can be cut out of an elongated strip of pre-printed material which is unwound from a supply roll. Alternatively, the display card 12″ can be cut out of individual sheets. The length l₄ and the width w₄ of the display card 12″ can vary to suit one's particular needs. The length l₄ can range from a couple of inches to a few feet, and the width w₄ can range from a couple of feet to several feet. The display card 12″ also has an upper edge 18″, a lower edge 20″ and a pair of side edges 22″ and 24″. The display card 12″ can be formed from any of the materials recited above with reference to the first or second embodiments.

Still referring to FIGS. 9 and 10, the display card 12″ is divided along its width w₄ by a number of score lines 26″ into n panels 28″. It is advantageous to pre-print the first major surface 14″ of the display card 12″ before the score lines 26″ are formed. However, if one wished to score the display card 12″ prior to printing the first major surface 14″, this is possible. Desirably, an odd number of score lines 26″ are utilized which divide the display card 12″ into an even number of equally wide panels 28″. For example, as depicted in FIG. 9, seven score lines 26″ and 30″ divide the display card 12″ into eight equally wide panels 28″. The score lines 26″ and 30″ can be linear or arcuate in configuration. Desirably, each of the five score lines 26″ and each of the two intermittent score lines 30″ are linear.

By forming an odd number of score lines 26″ and 30″, one will end up with an even number of panels 28″. Each of the score lines 26″ and 30″ can extend inward into the thickness t₁ of the display card 12″ from at least one of the first or second major surfaces, 14″ or 16″ respectively, by a distance of from between about 5% to about 90% of the thickness t₁. Desirably, the intermittent score line 30″ could extend inward from the first major surface 14″ a distance of from between about 10% to about 50% of the thickness t₁ of the display card 12″. More desirably, the intermittent score line 30″ could extend inward from the first major surface 14″ a distance of from between about 15% to about 40% of the thickness t₁ of the display card 12″. Even more desirably, the intermittent score line 30″ could extend inward from the first major surface 14″ a distance of from between about 20% to about 30% of the thickness t₁ of the display card 12″.

Desirably, the score lines 26″ are formed in the first major surface 14″. However, in some embodiments, it may be advantageous to form the score lines 26″ in the second major surface 16″. Alternatively, one could form the score lines 26″ in both the first and second surfaces, 14″ and 16″ respectively, of the display card 12″.

The score lines 26″ are aligned essentially parallel to one another and desirably, are aligned parallel to one another. The score lines 26″ can extend from approximately the upper edge 18″ to approximately the lower edge 20″. Desirably, the score lines 26″ extend from the upper edge 18″ to the lower edge 20″. A majority of the score lines 26″ can be continuous straight lines formed by displacing the material from which the display card 12″ is formed.

Still referring to FIGS. 9 and 10, the display card 12″ is divided into a number of n panels 28″. In FIGS. 9 and 10, n is equal to eight. Each of the panels 28″ can have an identical configuration. The eight panels 28″ are sufficient for constructing a finished snap mobile 10″ that can be view from multiple sides. Desirably, the snap mobile 10″ can be viewed by a potential consumer from 360 degrees. In FIGS. 9 and 10, the eight panels 28″ are labeled 1, 2, 3, 4, 5, 6, 7 and 8. The panels 28″ can also be referred to as a first panel, a second panel, a third panel, a fourth panel, a fifth panel, a sixth panel, a seventh panel and an eighth panel. Each of the eight panels 28″ has a width w₅. The width w₅ of each of the eight panels 28″, labeled 1, 2, 3, 4, 5, 6, 7 and 8 are equal or approximately equal.

The snap mobile 10″ also includes two intermittent score lines 30″. Desirably, the intermittent score lines 30″ are formed in the first major surface 14″ although they could be formed in the second major surface 16′, if desired. The two intermittent score lines 30″, 30″ are shown being formed between the third and fourth panels 28″, labeled 3 and 4 respectively, and between the seventh and eight panels 28″, labeled 7 and 8 respectively. The two intermittent score lines 30″, 30″ are aligned parallel with at least one of the other score lines 26″, and desirably, are aligned parallel to each of the other score lines 26″. Each of the two intermittent score lines 30″, 30″ extend approximately between the upper edge 18″ and the lower edge 20″. Desirably, each of the two intermittent score lines 30″, 30″ extends from the upper edge 18″ to the lower edge 20″.

Each of the two intermittent score lines 30″, 30″ is formed from a plurality of land areas 32″ each separated by a perforation 34″, as explained above.

Like the score lines 26″, each of the two intermittent score lines 30″, 30″ do not extend completely through the thickness t₁ of the display card 12″. However, each of the two intermittent score lines 30″, 30″ could extend completely through the thickness t₁ of the display card 12″, if desired. The two intermittent score lines 30″, 30″ should extend inward from the first major surface 14″ a distance of from between about 5% to about 90% of the thickness t of the display card 12. Desirably, each of the intermittent score lines 30″, 30″ could extend inward from the first major surface 14″ a distance of from between about 10% to about 50% of the thickness t₁ of the display card 12″. More desirably, each of the intermittent score lines 30″, 30″ could extend inward from the first major surface 14″ a distance of from between about 15% to about 40% of the thickness t₁ of the display card 12″. Even more desirably, each of the intermittent score lines 30″, 30″ could extend inward from the first major surface 14″ a distance of from between about 20% to about 30% of the thickness t₁ of the display card 12″.

It should be noted that the five score lines 26″ and the two intermittent score lines 30″, 30″ have been described as extending inward into the display card 12″ from the first major surface 14″. However, if desired, some or all of the score lines 26″ and the intermittent score lines 30″, 30″ can extend inward from the second major surface 16″.

Referring to FIG. 10, the display card 12″ further includes an attachment mechanism 36. The attachment mechanism 36 can be one of the types described above with reference to FIG. 1. Desirably, the attachment mechanism 36 is an adhesive that can adhere or stick to one or more of the panels 28″. The adhesive can be a hot melt adhesive, a cold melt adhesive, a co-adhesive, a paste, cement, glue, or any other adhesive known to those skilled in the adhesive art.

When the attachment mechanism 36 is an adhesive or glue, it can be positioned or applied onto at least a potion of the second major surface 16″. The adhesive or glue can be applied to one or more of the panels 28″. For example, the adhesive or glue can be applied to every one of the panels 28″, or to every other one of the panels 28″, such as panels 28″, labeled 1, 3, 5 and 7 or 2, 4, 6 and 8. Alternatively, the adhesive can be applied to the panels 28″, labeled 1, 2, 4 and 6 or 3, 5, 7 and 8. The adhesive can be applied in various ways, including but not limited to: being coated such as by line coating or slot coating, or be brushed, painted, applied in a swirl pattern, etc. onto the second major surface 16″. Those familiar with the applications of adhesive and glue will know of still other ways to apply the adhesive or glue.

When the attachment mechanism 36 is a mechanical fastener, such as pins, staples, clips, etc., they can be inserted along the pair of side edges 22″ and 24″ to hold the panels 28″, labeled 1 and 8 together. Additional pins, stapes, clips, etc. can also be applied to each of the other pairs of panels 28″, such as panels 28″, labeled 2 and 3, 4 and 5, and 6 and 7. Those skilled in mechanical fasteners will know of various other apparatus and methods which can be used to attach one or more of the panels 28″ to form the configuration shown in FIG. 11.

Referring now to FIGS. 11 and 12, in the case where the attachment mechanism 36 is an adhesive or glue which has been applied, the display card 12″ is folded. The folding can be done by hand or by using a mechanical folder. The display card 12″ is initially folded or reconfigured upon itself. In the eight panel profile shown in FIGS. 9 and 10, the panel 28″, labeled 1 is folded or reconfigured to overlap the panel 28″, labeled 8. In other words, the panel 28″, labeled 1, also referred to as the first or n−7 panel, is overlapped by the n^{th} panel 28″. The panel 28″, labeled 2, also referred to as the second or the n−6 panel, is folded or reconfigured to overlap the panel 28″, labeled 3, also referred to as the third or the n−5 panel. Likewise, the fourth panel 28″, labeled 4 is folded or reconfigured to overlap the panel 28″, labeled 5, also referred to as the fifth or n−3 panel, and the sixth panel 28″, labeled 6 is folded or reconfigured to overlap the panel 28″, labeled 7, also referred to as the seventh or n−1 panel.

At least a portion of the first panel 28″, labeled 1 is bonded to the eighth panel 28″, labeled 8 by the attachment mechanism 36. Likewise, at least a portion of the second panel 28″, labeled 2 is bonded to the third panel 28″, labeled 3 by the attachment mechanism 36, at least a portion of the fourth panel 28″, labeled 4 is bonded to the fifth panel 28″, labeled 5 by the attachment mechanism 36, and at least a portion of the sixth panel 28″, labeled 6 is bonded to the seventh panel 28″, labeled 7 by the attachment mechanism 36. If desired, only the first panel 28″, labeled 1 can be bonded to the eighth panel 28″, labeled 8. When this is the case, the second and third panels 28″, labeled 2 and 3 respectively, the fourth and fifth panels 28′, labeled 4 and 5 respectively, the sixth and seventh panels 28″, labeled 6 and 7 respectively, can be retained adjacent to one another by the stiffness of the material from which the display card 12″ is formed and/or by the amount of penetration of the score lines 26″ and 30″.

Still referring to FIGS. 11 and 12, after the initial fold or reconfiguration, the fourth and fifth panels 28″, labeled 4 and 5 respectively, form a set that is folded onto or in an overlapping fashion over the second and third panels 28″, labeled 2 and 3 respectively, and the sixth and seventh panels 28″, labeled 6 and 7 respectively, form a set that is folded onto or in an overlapping fashion over the first and eight panels 28″, labeled 1 and 8 respectively, see FIG. 11. This produces a relatively flat; two panel wide structure as depicted in FIG. 12. This relatively flat snap mobile 10″ is compact and can be easily boxed and shipped to a retailer or other consumer.

Referring now to FIG. 13, a top view of the snap mobile 10″ is shown once the four sets of panels 28″, labeled 1 and 8, 2 and 3, 4 and 5, and 6 and 7 are unfolded. The snap mobile 10″ has four legs, with each of the legs being spaced approximately 90 degrees apart. Each leg is constructed from a pair of the panels 28″. Each of the four sets of panels 28″, labeled 1 and 8, 2 and 3, 4 and 5, and 6 and 7 can be spaced apart at an angle θ. Desirably, the angle θ is approximately 90 degrees. However, it is possible to space the four sets of panels 28″, labeled 1 and 8, 2 and 3, 4 and 5, and 6 and 7 at different degrees from one another. For example, the first set, consisting of the panels 28″, labeled 1 and 8, can be spaced approximately 88 degrees apart from the second set, consisting of the panels 28″, labeled 2 and 3, and be spaced approximately 89 degrees apart from the fourth set, consisting of the panels 28″, labeled 6 and 7. The third set, consisting of the panels 28″, labeled 4 and 5 can be spaced approximately 92 degrees apart from the second set, consisting of the panels 28″, labeled 2 and 3, and be spaced approximately 91 degrees apart from the fourth set, consisting of the panels 28″, labeled 6 and 7.

The embodiment shown in FIG. 9 also has eight apertures 44 formed therein. Each of the eight apertures 44 is positioned adjacent to the upper edge 18″ and each is aligned with one of the score lines 26″ and 30″. In the folded position, shown in FIG. 11, all eight apertures 44 are coaxially aligned such that a line, string, cord, ribbon, metal wire, etc. can pass through them and be used to suspend the snap mobile 10″ from an elevated structure as was explained above.

### Method

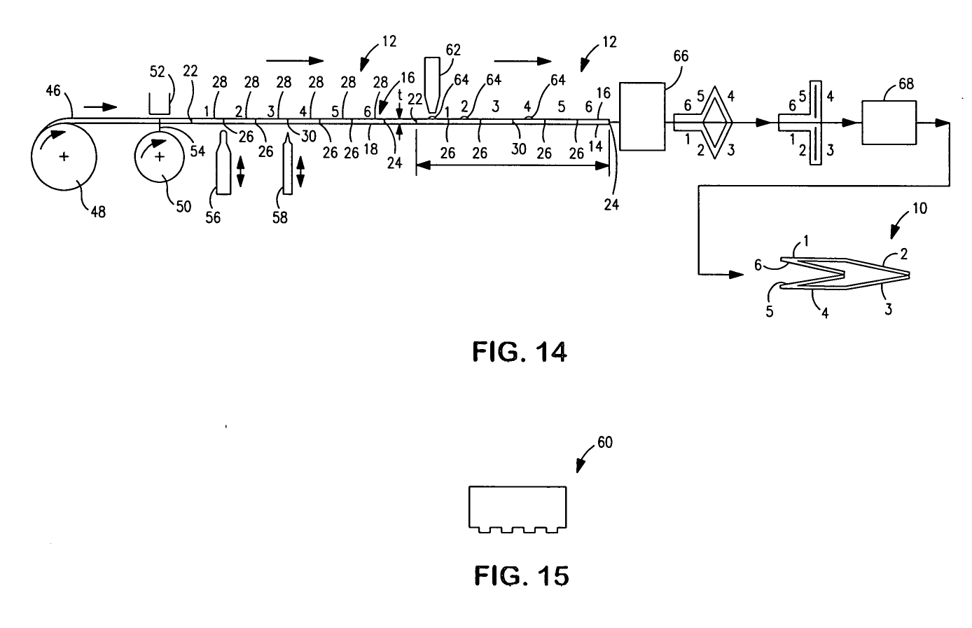

A method of forming the snap mobile 10 will now be explained with reference to FIGS. 14 and 15. This method can also be used to produce the snap mobile 10′ or 10″. The progression will be from the left to the right as the material advances through the process. It should be recognized that the method can be changed depending upon the equipment one has to work with and the form in which the starting material is supplied. The method includes the steps of unwinding a pre-printed strip of material 46 from a supply roll 48. Alternatively, one could start with individual sheets that have already been cut to a predetermined length l and width w. The pre-printed strip of material 46 has a first major surface 14 and an oppositely aligned second major surface 16. The first major surface 14 is printed while the second major surface 16 is optionally printed, as needed. The strip of pre-printed material 46 also has a thickness t.

The strip of pre-printed material 46 is passed between a cutter 50 and an anvil 52. The cutter 50 can be arranged above the anvil 52, if desired. The cutter 50 is depicted as a rotatable member having a single cutting blade 54 secured thereto. One or more cutting blades 54 can be arranged about the circumference of the cutter 50, if desired. The cutter 50 cuts the strip of pre-printed material 46 into individual display cards 12 each having a length l and a width w, an upper edge 18, a lower edge 20, see FIG. 1, and a pair of side edges 22 and 24.

A number of score lines 26 are then formed in the display card 12 by a first scoring mechanism 56. The score lines 26 can be formed into at least one of the first and second major surfaces, 14 and 16 respectively, of the individual display cards 12. Alternatively, the score lines 26 can be formed into each of the first and second major surfaces, 14 and 16 respectively.

A second scoring mechanism 58 is used to form at least one intermittent score line 30 into at least one of the first and second major surfaces, 14 and 16 respectively. Alternatively, the intermittent score line 30 can be formed into each of the first and second major surfaces, 14 and 16 respectively. Desirably, all of the score lines 26 and 30 are formed in the first major surface 14. The intermittent score line 30 can be formed by using a notched blade 60 as is depicted in FIG. 15.

The score lines 26 and 30 divide the width of each of the individual display cards 12 into n equally wide panels 28. Alternatively, the first and sixth panels 28, labeled 1 and 6 can have a width different from the width of the remaining panels 26. In FIG. 14, n is equal to six panels 28. The six panels 28 can be referred to as the first panel, labeled 1, a second panel, labeled 2, a third panel, labeled 3, a fourth panel, labeled 4, a fifth panel, labeled 5 and a sixth panel, labeled 6. The six panels 28 can also be referred to as the first panel or n−5, the second panel or n−4, the third panel or n−3, the fourth panel or n−2, the fifth panel or n−1 and the sixth panel or n.

The score lines 26 and 30 can extend from approximately the upper edge 18 to approximately the lower edge 20. At least one of the score lines is the intermittent score line 30. The intermittent score line 30 includes a plurality of land areas 32 each separated by a perforation 34. The perforations 34 can penetrate the thickness t of the display card 12 but do not have to. The intermittent score line 30 is formed at a midsection of the width w of each of the individual display cards 12 when the display card 12 contains six panels 28. When eight panels are present in a display card 12″, see FIG. 9, two intermittent score lines 30 are needed. The location of the two intermittent score lines 30″, 30″ in an eight panel display card 12″ will be different from the location of a single intermittent score line 30 in a six panel display card 12. The intermittent score line 30 permits the panel 28 to be folded a second time upon adjacent panels. If the intermittent score line 30 was not present, it would be more difficult to obtain a relatively flat profile for the folded snap mobile 10″. The intermittent score lines 30″ function in a similar fashion in the snap mobile 10″.

The method further includes using an attachment mechanism 36, such as an adhesive, to bond various panels 28 together. An adhesive applicator 62 can be used to apply an adhesive or glue, or a line or a swirl pattern of an adhesive 64 onto the second major surface 16. The adhesive 64 can be applied to a portion of the second major surface 16 or to the entire second major surface 16. The adhesive 64 can be applied by any of the various ways described above with reference to FIGS. 1-13. The adhesive 64 can be located on at least a portion of each of the panels 28, on approximately half of the panels 28, or on all of the panels 28. In FIG. 14, the adhesive 64 is shown being deposited or applied to the first, second and fourth panels 28.

The display card 12 is then passed through a first folding apparatus 66. At the first folding apparatus 66, the first panel 28, labeled 1 is folded or reconfigured to overlap the sixth or n^{th} panel 28, labeled 6. Simultaneously or sequentially, the third panel 28, labeled 3 is folded or reconfigured to overlap the second panel 28, labeled 2; and the fifth panel 28, labeled 5 is folded or reconfigured to overlap the fourth panel 28, labeled 4. Desirably, each pair of adjacent panels 2 and 3, and 4 and 5 overlaps each other. The two opposite end panels, 1 and 6, are overlapped as well. The folding can occur simultaneously or sequentially. The first panel 28, labeled 1 is secured by the attachment mechanism 36, i.e. the adhesive, to the sixth or n^{th} panel 28, labeled 6 as the two panels 1 and 6 are overlapped and pressed together. Likewise, the second and third panels 28, labeled 2 and 3, and the fourth and fifth panels 28, labeled 4 and 5, are secured together by the attachment mechanism 36, i.e. the adhesive, as they are overlapped upon one another and pressed together.

The display card 12 is then passed through a second folding apparatus 68. At the second folding apparatus 68, the fourth and fifth panels 28, labeled 4 and 5 or n−2 and n−1 panels, are folded or reconfigured relative to the first and sixth panels 28, labeled 1 and 6 to form a relatively flat, snap mobile 10 which can be easily shipped.

It should be understood that the snap mobiles 10, 10′ or 10″ can be formed by first printing a sheet of material, such as by feeding individual sheets into a printing press. The display cards 12, 12′ or 12″ can be die cut, scored and/or perforated. The uniquely formed display cards 12, 12′ or 12″ can then be folded and secured by an attachment mechanism 36 to form the finished snap mobile 10, 10′ or 10″.

The relatively flat, snap mobile 10 can be unfolded once it is ready to be used by a retailer or some other customer. The snap mobile 10 can be opened by moving one set of the panels 28 outward away from the other two sets of the panels 28, 28. For a six panel display card 12, the snap mobile 10 is opened into a three legged display wherein the legs are spaced approximately 120 degrees apart. For an eight panel display card 12″, the snap mobile 10″ is opened into a four legged display card 12″ wherein the legs are spaced approximately 90 degrees apart. For a ten panel display card, not shown, the snap mobile is opened into a five legged display card wherein the legs are spaced approximately 72 degrees apart.

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications and variations which fall within the spirit and scope of the appended claims.

I claim:

1. A snap mobile for advertising a product, comprising:
a) a display card having a first major surface and an oppositely aligned second major surface, said display card having a width divided by at least five score lines into at least a first panel, a second panel, a third panel, a fourth panel, a fifth panel and a sixth panel, each of said panels having an equal width;
b) one of said score lines being an intermittent score line that is formed at a midsection of the width of said display card, and said intermittent score line having a plurality of land areas each separated by a perforation; and
c) an attachment mechanism used to secure at least a portion of said first panel to said sixth panel, said first panel being overlapped onto said sixth panel, said second panel being overlapped onto said third panel, and said fourth panel being overlapped onto said fifth panel, and said fourth and fifth panels being folded upon said sixth panel to form a relatively flat snap mobile which can be easily shipped.

2. The snap mobile of claim 1 wherein said score lines are linear and aligned parallel to one another.

3. The snap mobile of claim 2 wherein each of said six panels has an identical configuration.

4. The snap mobile of claim 3 wherein said relatively flat snap mobile can be unfolded into a three legged display and each leg being spaced approximately 120 degrees apart.

5. The snap mobile of claim 1 wherein said first major surface is printed.

6. The snap mobile of claim 5 wherein each of said score lines is formed in said first major surface.

7. The snap mobile of claim 1 wherein said perforations do not extend completely through said display card from said first major surface to said second major surface.

8. The snap mobile of claim 1 wherein said perforations extend completely through said display card from said first major surface to said second major surface.

9. The snap mobile of claim 8 wherein said relatively flat snap mobile can be unfolded into a four legged display and each leg being spaced approximately 90 degrees apart.

10. A snap mobile for advertising a product, comprising:
a) a display card having a first major surface and an oppositely aligned second major surface and having a thickness therebetween, said display card having a width, an upper edge, a lower edge and a pair of side edges, said first major surface of said display card being divided along said width by an odd number of score lines into n equally wide panels, said score lines extending from approximately said upper edge to approximately said lower edge;
b) one of said score lines being an intermittent score line that is formed at a midsection of the width of said display card, said intermittent score line having a plurality of land areas each separated by a perforation, and said intermittent score line extending between said upper and lower edges; and
c) an adhesive applied to a portion of said second major surface and located on at least alternating n panels, said first panel being overlapped onto said n^{th} panel, said second panel being overlapped onto said n−3 panel, etc., said first panel being secured to said n^{th} panel by said adhesive, said second panel being secured to said n−3 panel by said adhesive, etc., and said n−1 and n−2 panels being folded upon said n^{th} panel to form a relatively flat snap mobile which can be easily shipped.

11. The snap mobile of claim 10 wherein n is six.

12. The snap mobile of claim 11 wherein said relatively flat snap mobile can be unfolded into a display having three legs and each of said legs being spaced approximately 120 degrees apart.

13. The snap mobile of claim 12 further including an aperture formed in each of said three legs approximate said upper edge whereby said display card can be hung by a line from an elevated member.

14. The snap mobile of claim 10 wherein n is eight.

15. The snap mobile of claim 14 wherein said relatively flat snap mobile can be unfolded into a display having four legs and each of said legs being spaced approximately 90 degrees apart.

16. A method of forming a snap mobile comprising the steps of:
a) unwinding a pre-printed strip of material from a supply roll, said strip of material having a first major surface and an oppositely aligned second major surface;
b) cutting said strip into individual display cards each having a length, a width, an upper edge and a lower edge;
c) forming an odd number of score lines into at least one of said first and second major surfaces, said scoring dividing said width into n equally wide panels, said score lines extending from approximately said upper edge to approximately said lower edge, one of said score lines being an intermittent score line that is formed at a midsection of said width of each of said individual display cards, and said intermittent score line having a plurality of land areas each separated by a perforation;
d) applying an adhesive to at least a portion of said second major surface, said adhesive being located on at least half of said panels; and
f) overlapping said first panel with said n^{th} panel, overlapping at least one other panel onto an adjacent panel, said first panel being secured to said n^{th} panel by said adhesive, and said n−1 and n−2 panels being folded upon said n^{th} panel to form a relatively flat snap mobile which can be easily shipped.

17. The method of claim 16 wherein five score lines are formed in said display card and n is six.

18. The method of claim 17 wherein seven score lines are formed in said display card and n is eight.

19. The method of claim 16 wherein said display card has a thickness and said perforations of said intermittent score line do not penetrate said thickness.

20. The method of claim 16 further comprising sequentially folding each of said panels upon another panel and then folding said n−1 and n−2 panels upon said n^{th} panel to form a relatively flat snap mobile which can be easily shipped.

21. The method of claim 16 further comprising unfolding said relatively flat snap mobile into a display having three legs and each of said legs being spaced approximately 120 degrees apart.

22. The method of claim 16 further comprising unfolding said relatively flat snap mobile into a display having four legs and each of said legs being spaced approximately 90 degrees apart.
